(19) United States
(12) Patent Application Publication
(10) Pub. No.: US 2006/0146967 A1
(43) Pub. Date: Jul. 6, 2006

(54) Keep-out asynchronous clock alignment scheme

(76) Inventors: Adarsh Panikkar, Tacoma, WA (US); Daniel S. Klowden, Seattle, WA (US); S. Reji Kumar, University Place, WA (US)

Correspondence Address: MARGER JOHNSON & MCCOLLOM, P.C., 210 SW MORRISON STREET, SUITE 400, PORTLAND, OR, 97204, US

(21) Appl. No.: 11/027,773

(22) Filed: Dec. 31, 2004

(51) Int. Cl. H04L 7/00

(52) U.S. Cl. 375/355

(57) ABSTRACT

In some embodiments an apparatus may comprise a data circuit, a clock circuit to synchronize the data circuit; and a sampling circuit to sample a clock signal from a separate clock domain, the sampling circuit may control the clock circuit in response to the sampled clock signal and to delay the data circuit from providing data if it would result in data corruption due to clock misalignment.

### BACKGROUND

Electronic devices and systems often represent information by varying electrical parameters such as voltage, current, frequency, wavelength, etc. These electrical parameters may be controlled in many ways, for example, a digital device may vary a voltage amplitude discretely over time while an analog device may vary a voltage amplitude continuously over time. These two variations alone provide limitless ways to represent information.

Digital devices are further differentiated as synchronous or asynchronous. Synchronous devices use periodic synchronization signals, also called clock pulses, to synchronize device circuitry while asynchronous devices are not slaved to a clock. Synchronous signaling is typically less complex and has less overhead than asynchronous signaling, which benefits device performance.

Unfortunately, synchronous devices and systems are susceptible to errors within their clock signals. Ideally, a synchronous system has universal clock signal characteristics such as phase or frequency throughout the entire system. This is not achieved in practice. Some potential sources of error are environmental influences on clocking, clock distribution variations, and signaling between clock domains.

In devices or systems that are synchronized with a clock signal, slight variations in the clock signal cause malfunctions. If a signal is sampled at a wrong time, data corruption occurs. For example, metastability happens if a data signal transitions too close to or at the same time as a clock transition, causing the data signal to be sampled in an invalid intermediate state. In order to reliably sample a data value the value must be steady for a brief time before a clock transition through a brief time after a clock transition, also called setup time and hold time, respectively.

When signals are passed between clock domains, from circuitry running on one clock to circuitry running on another clock, asynchronous relationships at the clock domain interface must be reconciled to ensure data integrity. Since each domain is operating on different clocks, numerous sources for error exist. For example, clock domain interfaces may have an unknown phase relationship even if the two clock domains are operating at the same frequency. Therefore data corruptions are likely if not otherwise compensated for.

### BRIEF DESCRIPTION OF THE DRAWINGS

FIG. 1 illustrates a clock domain interface where clock signals have matching frequency but no phase relationship.

FIG. 2 illustrates a data pattern frame alignment by using a control signal.

FIG. 3 illustrates clock signal and data adjustments to prevent data from being released near the capture edge of a receiving clock signal.

FIG. 4 illustrates a control signal being delayed due to a timing conflict.

FIG. 5 illustrates an implementation to generate delay signals.

FIG. 6 illustrates an example circuit to add delay to data path.

### DETAILED DESCRIPTION

In the following description, numerous specific details are set forth. However, it is understood that embodiments of the inventions may be practiced without these specific details. In other instances, well-known circuits, structures, and techniques have not been shown in detail in order to improve the understanding of this description. Reference in the specification to “one embodiment” or “an embodiment”, etc., means that a particular feature, structure, or characteristic described in connection with the embodiment is included in at least one aspect of the invention. The appearances of the phrase “in one embodiment” in various places in the specification do not necessarily all refer to the same embodiment.

In general, when transferring signals across a clock domain interface, that is between circuitry running on one clock and other circuitry running on another clock, clocking information from one domain may be used in the other clock domain in a manner that avoids data corruptions while sending data signals across the interface.

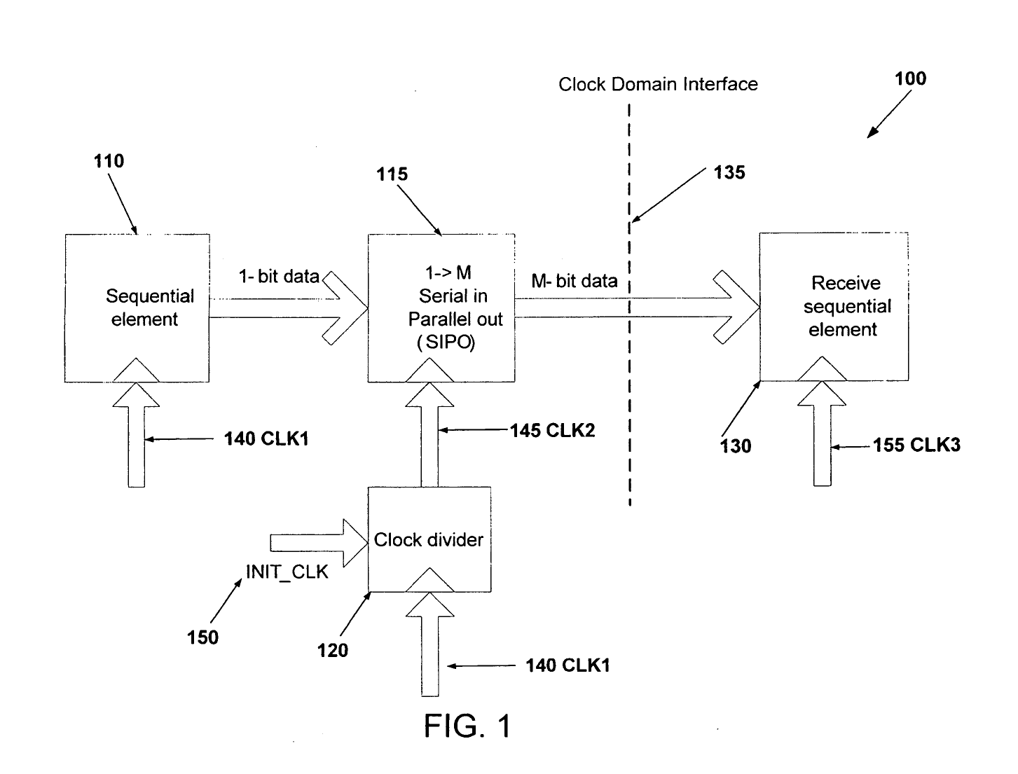

FIG. 1 illustrates circuitry 100 distributed on two sides of a clock domain interface 135. In the present example, the circuitry on one side of the clock domain interface 135 includes circuitry to match the clock frequency on the other side of the clock domain interface 135. Even with matching frequencies, the clock domain interface 135 can be asynchronous in phase and therefore increase the number of data corruptions as data crosses the clock domain interface 135.

Referring to the embodiment in FIG. 1, a sequential element 110 is clocked by CLK1 140 and outputs 1-bit data to a serial in parallel out element (SIPO) 115. A clock divider 120 receives CLK1 140 as well as an INIT_CLK signal 150 and divides CLK1 to make a CLK2 signal 145 that may be equal in frequency to a clocking signal on the other side of the clock domain interface 135. The SIPO 115 is clocked by CLK2 and outputs the input 1-bit data from sequential element 110 as M-bit data. The M-bit data may be sent in a frame such as an M-bit pattern of data sent out at each CLK 2 cycle. Therefore, the present example provides synchronous data to a clock domain interface at a matching frequency to circuitry on the other side of the clock domain interface.

A receive sequential element 130 is clocked by CLK3 155 and receives the M-bit data across the clock domain interface 135 from the SIPO 115. CLK 2 need not be a division of CLK1, it may be larger, smaller or equal, therefore the clock divider 120 is used for illustration purposes. Furthermore, the present embodiment uses 1-bit data and M-bit data, but embodiments of the present invention need not be limited to any data widths and therefore may be applied to any clocked data.

An embodiment may comprise a data circuit, a clock circuit to synchronize the data circuit, and a sampling circuit to sample a clock signal from a separate clock domain. In this embodiment the sampling circuit may control the clock circuit in response to a sampled clock signal and may delay the data circuit from providing data if it would result in data corruption due to clock misalignment. In an embodiment the sampling circuit may further control the clock circuit with a signal that bounds the setup and hold window of the sampled clock signal.

Therefore, the embodiment in FIG. 1 shows an example clock domain interface 135 with two clocks, CLK2 145 and CLK3 155, that are equal in frequency but have no phase relationship and a data bus that traverses the interface 135. In this example, CLK1 140 is divided to produce CLK2 145 which therefore has a synchronous phase relationship to CLK1 140. CLK2 145 is used to clock SIPO 115 to send data from the CLK1 140 domain.

This embodiment illustrates phase control of CLK2 145 with the INIT_CLK signal 150, which is a control signal in the CLK1 domain. In this case, if INIT_CLK 150 is deasserted, CLK2 145 initializes to produce a transition, such as a rising edge. By adjusting the CLK2 phase, a frame alignment of the M-bit data bus can be set.

An embodiment may further comprise a data delay circuit to delay data in the data circuit in response to the clock circuit delaying data provided from the data circuit. In an embodiment the data delay circuit adds delay to the data circuit only when needed to prevent data corruption. In an embodiment a data circuit may internally process data serially and provide parallel data.

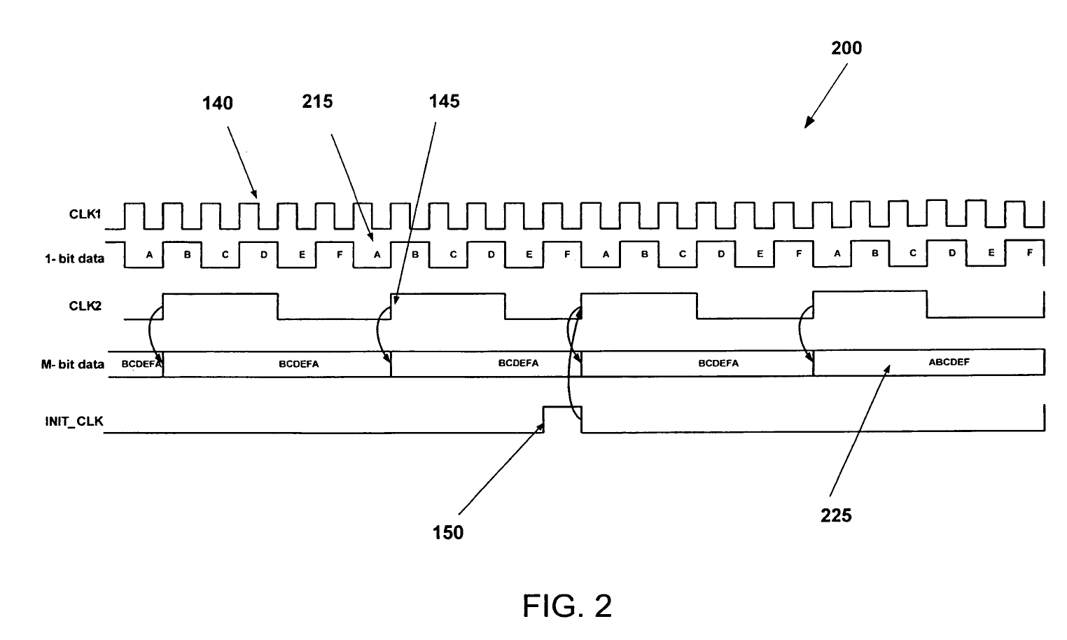

FIG. 2 shows an example frame alignment 200 of data with ABCDEF 225 being the desired alignment. FIG. 2 includes CLK1 signal 140, 1-bit data 215, CLK2 signal 145, M-bit data 225 and an INIT_CLK signal 150. In the present example, CLK2 has a synchronous phase relationship with CLK1 and has M-bit data in frames of 6 bits each. The following examples use 6 bit data frames by setting M=6, but embodiments of the present invention are not limited regarding data size.

Referring to the example in FIG. 2, before frame alignment CLK2 transitions high while 1-bit data 215 becomes a B value. When INIT_CLK transitions low, CLK2 transitions high, thus starting the subsequent frame while the 1-bit data 215 is A. The subsequent M-bit data 225 frame will thus have the desired frame alignment.

Referring back to FIG. 1, it is possible that CLK2 is initialized such that the sent M-bit data arrives during the CLK3 receive element's setup/hold window, causing data corruption. An embodiment can prevent data corruption by defining a keep-out window where CLK2 cannot be initialized.

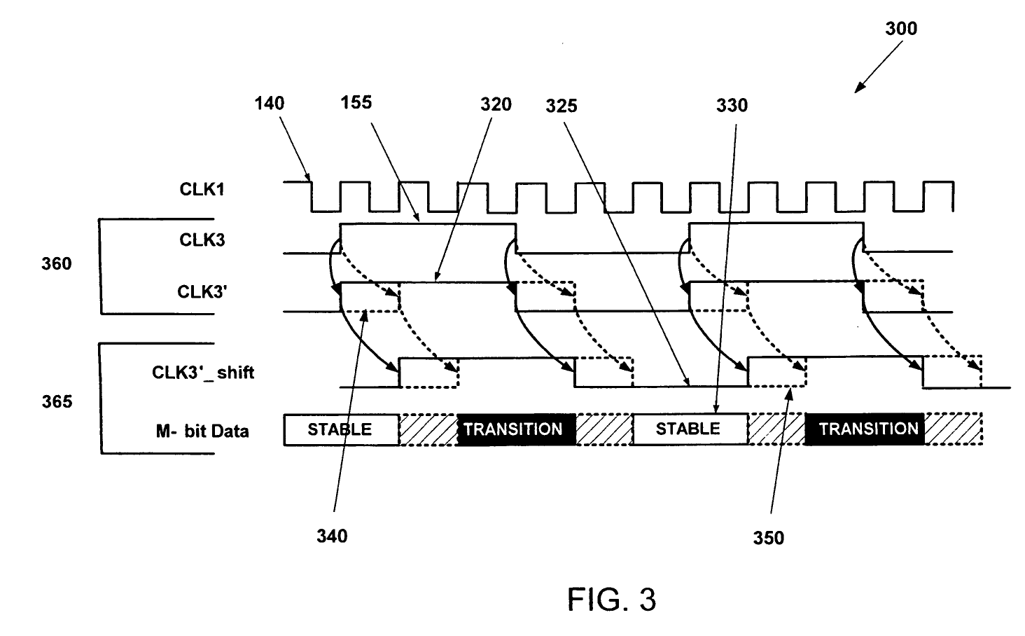

The present embodiment eliminates phase conflict between CLK2 and CLK3 by considering three things. By sampling CLK3 in the CLK1 domain, the CLK1 domain can adjust timing to avoid data corruptions for data traversing the clock domain interface 135. The sampling of CLK3 is shown in FIG. 3 at reference 360. Also, a signal derived from the sampled CLK3 may be generated to have a fixed level bounding the rising edge window of CLK3, as represented by reference 365 in FIG. 3. The other consideration involves delaying the phase of CLK2 with the INIT_CLK signal 150 to prevent data from being released in a keep-out region. Additionally, delay may be added to the data-path to maintain frame alignment.

An embodiment may be a system comprising a first element to provide data and to use a first clock signal in a first clock domain, a clock divider to generate a second clock signal from the first clock signal, a second element to receive data from the first element, the second element to use the second clock signal and to output data to a second clock domain, a receive sequential element to receive data from the second element, the receive sequential element to use a third clock signal and to operate in the second clock domain, and circuitry to sample the third clock signal, generate a control signal with a fixed level bounding transitions in the third clock signal, and provide to the clock divider a control signal to adjust the phase of the second clock signal and align data released from the second element with the third clock signal.

In an embodiment the circuitry may delay the data entering the second element. This embodiment may add delay to the data only when needed to prevent data corruption at the receive sequential element. In an embodiment the data from the sequential element may be serial data. In an embodiment the second element may be a serial in parallel out (SIPO) element.

FIG. 3 illustrates clock signal and data adjustments to prevent data from being released near the capture edge of a receiving clock signal. FIG. 3 shows timing 300 of elements in FIG. 1 and how to prevent data corruptions for data crossing the clock domain interface 135. FIG. 3 includes signals CLK1 140, CLK3 155, CLK3′ 320, CLK3′_shift 325 and M-bit data 330 which shows states of the M-bit data, for example, when the M-bit data is in transition, when it is stable, and when there is uncertainty as to its state.

The two waveforms referenced at 360 highlight re-sampling of CLK3 to the CLK1 domain. The sampled CLK3 in the CLK1 domain is referred to as CLK3′. At reference 365, CLK3′_shift is generated from the sampled CLK3 and has a fixed level bounding the rising edge window of CLK3. Furthermore, references 340 and 350 represent uncertainty periods each of duration of 1 CLK1 cycle, as is shown by the dashed waveforms. Generally, FIG. 3 shows derivation of a signal that indicates where CLK3 is stable and where it is in transition, as well as when it is uncertain, so that the signal may be used to avoid data corruptions when data is sent to the CLK3 domain. For this figure, M=6, or six periods of CLK1 for every period of CLK3.

Referring to FIG. 3 at reference 365, CLK3′_shift is derived from CLK3′ to bound the setup/hold window of CLK3. Due to uncertainty, the low-level of CLK3′_shift may begin 1-2 CLK1 cycles before the CLK3 rising edge and may end 1-2 CLK1 cycles after the CLK3 rising edge. In the present embodiment, CLK3′_shift is generated such that its level low state bounds the rising edge of the original CLK3 signal, is could also bound the falling edge of the original CLK3 signal.

CLK3′_shift can now be used to prevent M-bit data from being released on CLK2 near the capture edge of CLK3. FIG. 3 shows how the level of CLK3′_shift dictates when M-bit data should be stable vs. transitioning in order to prevent data corruption. Depending on variations in the logic to generate CLK3′_shift, it is possible to increase or shift the stable and transition regions.

CLK3′_shift and INIT_CLK can now be used to prevent data being released from the SIPO 115 near the capture edge of CLK3. By constraining the assertion of INIT_CLK to occur only during the “TRANSITION” region shown in FIG. 3, there will be no rising edges of CLK2 releasing data near the rising edge of CLK3. In short, CLK3′_shift can be considered a “keep-out” region for the assertion of INIT_CLK. If INIT_CLK tries to assert within this “keep-out” region, the assertion is delayed until the “keep-out” region passes. In order to maintain frame alignment, for every CLK1 cycle that INIT_CLK is delayed, 1 cycle of additional delay may be added to the 1-bit data coming into the SIPO.

An embodiment may be a method comprising sending data from a first clock domain to a separate second clock domain, sampling a clock signal from the second clock domain, and using the sampled clock signal to delay a clock signal in the first clock domain to avoid corruption of data passed between the clock domains. In an embodiment the clock signal delay is at least 1 cycle in a first clock domain. An embodiment may delay data in the first clock domain to correspond with the delayed clock signal. An embodiment may delay the data in the first clock domain only happens when needed to prevent data corruption.

An embodiment may delay a clock signal in the first clock domain when it otherwise would transition in the setup and hold window of a sampled clock from a second clock domain.

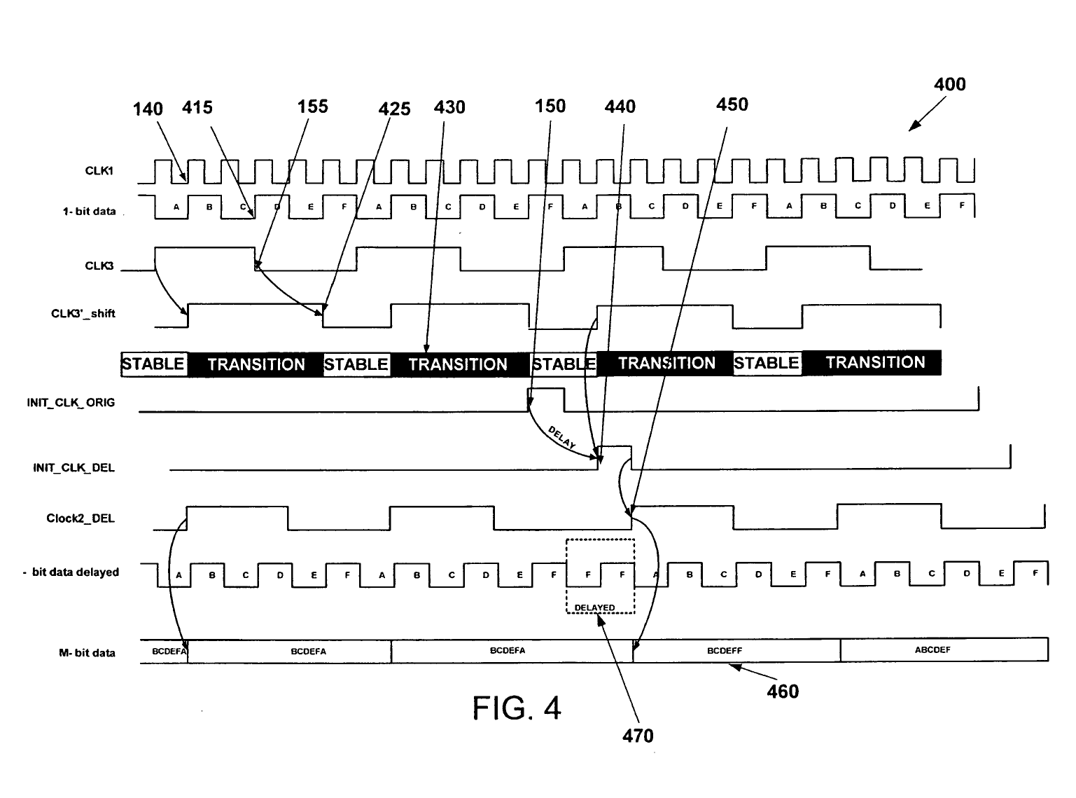

FIG. 4 illustrates an embodiment where INIT_CLK is adjusted. FIG. 4 shows timing 400 of elements in FIG. 1 and includes signals CLK1 140, 1-bit data 415, CLK3 155, CLK3′_shift 425 including where CLK3′_shift represents states of CLK3 at 430, INIT_CLK signal 150, INIT_CLK_DEL signal 440, Clock2_DEL signal 450, M-bit data 460 and 1-bit data delayed 470 representation.

Referring to FIG. 4, CLK3′_shift 425 is shown with the smallest possible keep-out region due to uncertainty. In this case, the rising transition is caught immediately and the falling edge misses a cycle. INIT_CLK_ORIG 150 shows the original INIT_CLK signal, and without adjustment would initialize CLK2 to release the M-bit data frame at the exact time of the rising edge of CLK3. The INIT_CLK_ORIG signal is delayed to generate INIT_CLK_DEL 440. For each CLK1 cycle that the INIT_CLK signal is delayed, the 1-bit data 415 is also delayed as represented by dashed box around the 1-bit delayed waveform 470. By delaying INIT_CLK and the data, the required frame alignment, in this case ABCDEF as shown in the waveform, may be maintained with the data release two cycles after the rising edge of CLK3.

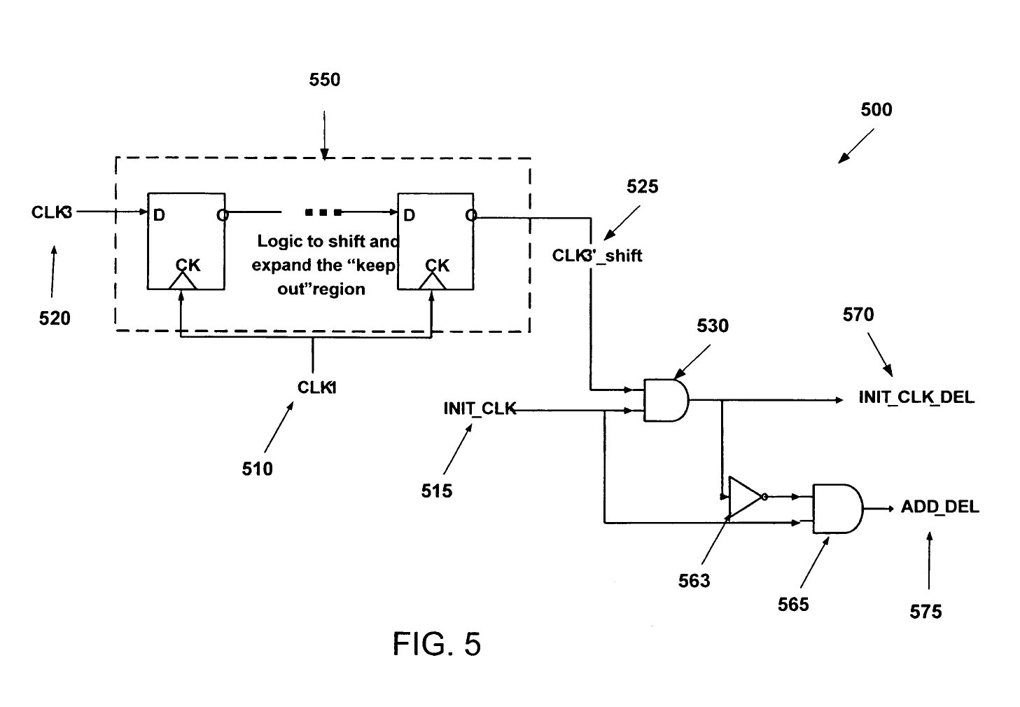

FIG. 5 illustrates an implementation to generate delay signals including INIT_CLK_DEL 570, represented in FIG. 4 as reference 440, and ADD_DEL signal 575, to delay the data when the INIT_CLK signal is delayed as represented in FIG. 4.

Referring to the embodiment illustrated in FIG. 5, CLK3′_shift 525 is created from CLK3 520 by traversing logic that adjusts the keep out region in dashed block 550. CLK3′_shift 525 and INIT_CLK 515 are then input to AND gate 530. The output of AND gate 530 is the INIT_CLK_DEL signal 570 and is also inverted and input to AND gate 565 along with INIT_CLK 515. The output of AND gate 565 is ADD_DEL signal 575. One aspect that is not shown in the implementation in FIG. 5 is logic that clears the INIT_CLK signal once INIT_CLK_DEL is asserted.

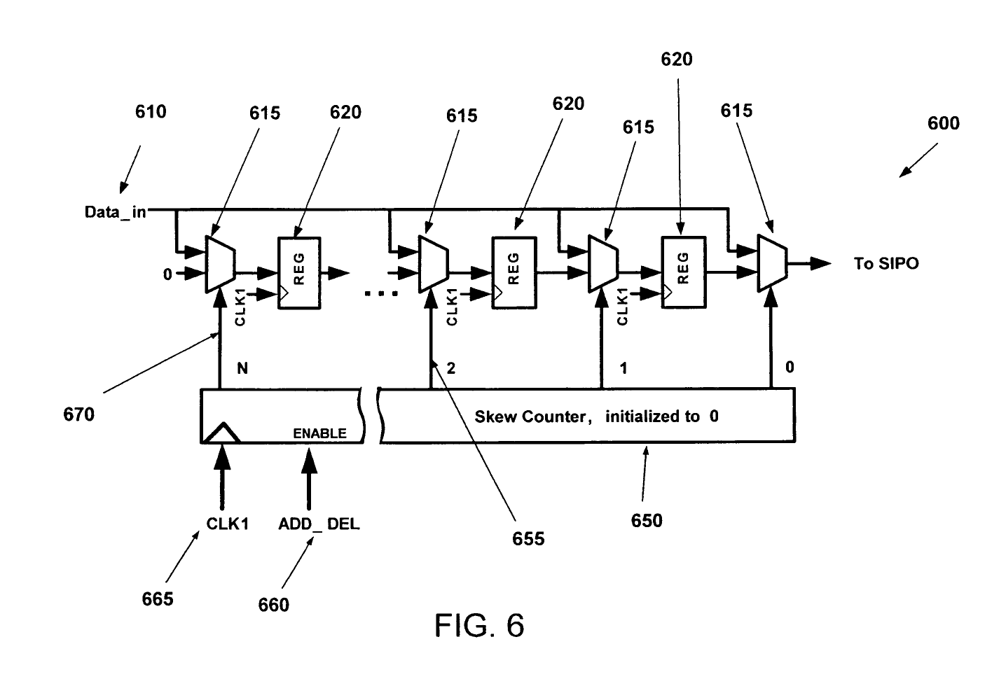

FIG. 6 shows an example circuit to add delay to a data path as shown at 470 in FIG. 4. Circuit 600 includes a Data_in 610 path that fans out to a serial group of multiplexers 615. The multiplexers 615 output serially through subsequent registers 620 that each add 1 cycle of latency. The multiplexers 615 are selected by a skew counter 650 that has a sequence of outputs to select each multiplexer, as represented by lane 670, lane 655, etc. Circuit 600 selects how many sequential registers to send Data_in 610 through, resulting in a variable delay circuit, by enabling one of lane 670, lane 655, etc., at a time to increase stages of delay.

In an embodiment, the phase relationship of two clocks, on either side of a clock domain interface, is analyzed and automatically adjusted during initialization. In an embodiment latency is only added to the data path when needed to prevent data corruption.

Embodiments of the present invention may also eliminate the need for area-intensive elastic buffers that have traditionally been used in clock crossings, may prevent data corruption due to an asynchronous clock interface, may remove fixed latency associated with clock crossing logic, and are adaptable to any frequency ratio and data bus width. In an embodiment, the defined “keep-out” region is adjustable to begin and end at any rising edge of the fast CLK1 within 1 cycle, due to uncertainty.

The present invention may be embodied in other specific forms without departing from its spirit or essential characteristics. The described embodiments are to be considered in all respects only as illustrative instead of restrictive or limiting. Therefore, the scope of the invention is indicated by the appended claims rather than by the foregoing description. All changes, modifications, and alterations that come within the meaning, spirit, and range of equivalency of the claims are to be embraced as being within the scope of the appended claims.

1. An apparatus comprising:
a data circuit;
a clock circuit to synchronize the data circuit; and
a sampling circuit to sample a clock signal from a separate clock domain, the sampling circuit to control the clock circuit in response to the sampled clock signal and to delay the data circuit from providing data if it would result in data corruption.

2. The apparatus of claim 1 further comprising a data delay circuit to delay data in the data circuit in response to the clock circuit delaying data provided from the data circuit.

3. The apparatus of claim 2 wherein the data delay circuit adds delay to the data circuit only when needed to prevent data corruption.

4. The apparatus of claim 1, the data circuit to internally process data serially and to provide parallel data.

5. The apparatus of claim 1, the sampling circuit further to control the clock circuit with a signal to bound the setup and hold window of the sampled clock signal from a separate clock domain.

6. The apparatus of claim 1 further comprising circuitry to align a data frame to the sampled clock signal.

7. The apparatus of claim 1, the data circuit to provide serial data.

8. A method comprising:
sending data from a first clock domain to a separate second clock domain;
sampling a clock signal from the second clock domain; and
using the sampled clock signal to delay a clock signal in the first clock domain to allow data to be passed between the clock domains without corruption.

9. The method of claim 8 further comprising delaying data in the first clock domain to correspond with the delayed clock signal.

10. The method of claim 8 wherein the delaying data in the first clock domain only happens when needed to prevent data corruption.

11. The method of claim 8 wherein avoiding corruption of data passed between clock domains is achieved by delaying a clock signal in the first clock domain when it otherwise would transition in the setup and hold window of the sampled clock from the second clock domain.

12. The method of claim 8 further comprising aligning a data frame to the clock signal in the second clock domain.

13. The method of claim 8 wherein the clock signal delay is at least 1 cycle in the first clock domain.

14. A system comprising:
a first element to provide data and to use a first clock signal in a first clock domain;
a clock divider to generate a second clock signal from the first clock signal;
a second element to receive data from the first element, the second element to use the second clock signal and to output data to a second clock domain;
a receive element to receive data from the second element, the receive element to use a third clock signal and to operate in the second clock domain; and
circuitry to:
sample the third clock signal;
generate a control signal with a fixed level bounding transitions in the third clock signal; and
provide to the clock divider a control signal to adjust the phase of the second clock signal and align data released from the second element with the third clock signal.

15. A system according to claim 14 the circuitry further to delay the data entering the second element.

16. The system of claim 15 wherein the circuitry adds delay to the data only when needed to prevent data corruption at the receive element.

17. The system of claim 14 wherein the data from the second element is serial data.

18. A system according to claim 14, wherein the second element is a serial in parallel out (SIPO) element.

19. A system according to claim 14, the circuitry further to align a data frame with the third clock signal.

20. A system according to claim 14, wherein the second element is a serial out element.
